(19) United States
(12) Patent Application Publication
(10) Pub. No.: US 2016/0330400 A1
(43) Pub. Date: Nov. 10, 2016

(54) METHOD, APPARATUS, AND COMPUTER PROGRAM PRODUCT FOR OPTIMISING THE UPSCALING TO ULTRAHIGH DEFINITION RESOLUTION WHEN RENDERING VIDEO CONTENT

(71) Applicant: THOMSON LICENSING, Issy-Les-Moulineaux (FR)

(72) Inventors: Bruce Kevin LONG, Los Angeles, CA (US); Daryll STRAUSS, Redondo Beach, CA (US)

(21) Appl. No.: 15/109,640

(22) PCT Filed: Dec. 29, 2014
(86) PCT No.: PCT/US2014/072570

§ 371 Date: Jul. 3, 2016

Related U.S. Application Data
(60) Provisional application No. 62/018,039, filed on Jun. 27, 2014.
(60) Provisional application No. 61/923,478, filed on Jan. 3, 2014.

(51) Int. Cl. H04N 7/01; H04N 21/235; H04N 21/435; H04N 5/262

(52) U.S. Cl. CPC H04N 7/0117; H04N 5/262; H04N 21/2356; H04N 7/0125; H04N 21/4356

(57) ABSTRACT

A process for improved upscaling and picture optimization in which the original lower resolution content is analyzed and metadata for the upscaling and optimization of the content is created. The metadata is then provided along with the content to an upscaling device. The upscaling device can then use the metadata to improve the upscaling which can in turn be incorporated into higher resolution content.

### CROSS REFERENCE TO RELATED APPLICATIONS

This application claims the benefit of U.S. Provisional Application Ser. No. 61/923,478 filed Jan. 3, 2014 which is incorporated by reference herein in its entirety.

### BACKGROUND

1. Technical Field

The present invention generally relates to video optimization and more specifically to improving the upscaling of lower resolution visual effects for inclusion in high resolution video.

2. Description of Related Art

For many films and television shows visual effects shots make up a significant portion of the time and money involved. This problem only increases when higher resolution, such as 4K is involved. What is needed is way that lower resolution visual effects (produced at reduced cost) can be up-scaled and provided for use in higher resolution content using.

### SUMMARY

A process for improved upscaling and picture optimization in which the original lower resolution content is analyzed and metadata for the upscaling and optimization of the content is created. The metadata is then provided along with the content to an upscaling device. The upscaling device can then use the metadata to improve the upscaling which can in turn be incorporated into higher resolution content.

One embodiment of the disclosure provides a method for optimizing the rendering of visual effects. The method involves receiving visual effect content in a first resolution, processing the visual effect content to generate metadata for use in rendering the visual effect content in a second resolution, and providing the metadata for use in rendering the visual effect content in a second resolution.

Another embodiment of the disclosure provides an apparatus for method for optimizing the rendering of visual effects. The apparatus includes storage, memory and a processor. The storage and memory are for storing data. The processor is configured to receive visual effect content in a first resolution, process the visual effect content to generate metadata for use in rendering the visual effect content in a second resolution, and provide the metadata for use in rendering the visual effect content in a second resolution.

Another embodiment of the disclosure provides a method of rendering the visual effect content using metadata. The method involves receiving the visual effect content at a first resolution, receiving the metadata for optimizing the rendering of the visual effect content, processing the visual effect content and metadata, and outputting visual effect content at a second resolution.

Another embodiment of the disclosure provides an apparatus for method for optimizing the rendering of visual effects. The apparatus includes storage, memory and a processor. The storage and memory are for storing data. The processor is configured to receive visual effect content at a first resolution, receive metadata for optimizing the rendering of the visual effect content, process the visual effect content and metadata, and output visual effect content at a second resolution.

Objects and advantages will be realized and attained by means of the elements and couplings particularly pointed out in the claims. It is important to note that the embodiments disclosed are only examples of the many advantageous uses of the innovative teachings herein. It is to be understood that both the foregoing general description and the following detailed description are exemplary and explanatory and are not restrictive of the invention, as claimed. Moreover, some statements may apply to some inventive features but not to others. In general, unless otherwise indicated, singular elements may be in plural and vice versa with no loss of generality. In the drawings, like numerals refer to like parts through several views.

### BRIEF SUMMARY OF THE DRAWINGS

FIG. 1 depicts a block schematic diagram of a system in which the optimization of visual effects can be implemented according to an embodiment.

FIG. 2 depicts a block schematic diagram of an electronic device for implementing the methodology of visual effects optimization according to an embodiment.

FIG. 3 depicts an exemplary flowchart of a methodology for visual effects optimization according to an embodiment.

FIG. 4 depicts an exemplary flowchart of a methodology for content processing step of FIG. 3 according to an embodiment

FIG. 5 depicts an exemplary flowchart of a methodology for the optimization of rendering of visual effects using metadata step of FIG. 3 according to an embodiment.

FIG. 6 depicts one example of how up-scaled visual effects can be combined with native high resolution video.

### DETAILED DESCRIPTION

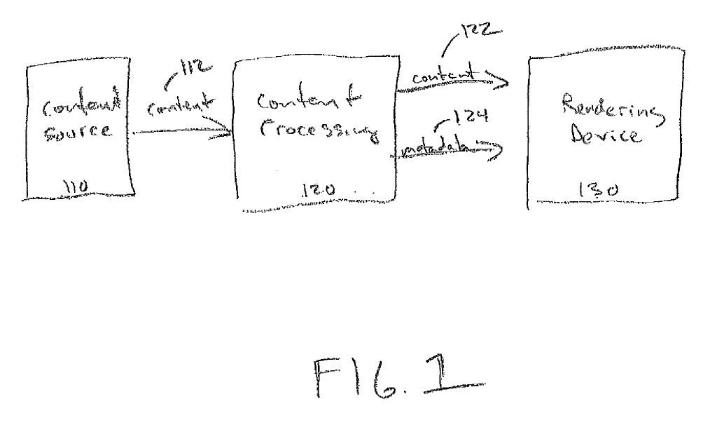

Turning now to FIG. 1, a block diagram of an embodiment of a system 100 for implementing content optimization in view of this disclosure. As such the system 100 includes a content source 110, content processing 120, and a rendering device such as an upscaler 130. Each of these will be discussed in more detail below.

The content source 110 may be a server, or other storage device such as a hard drive, flash storage, magnetic tape, optical disc, or the like. The content source 110 provides content 112 such as visual effects (VFX) shots to content processing 120. The content may be in any number of formats and resolutions. For the purposes of this disclosure, the visual effects are at a lower resolution than desired. For example, the visual effects may be in High Definition (2K).

The content processing 120 is where the content is analyzed to determine how to best optimized the upconversion or scaling of the content. This can be performed by a person or a computer system, or a combination of both. In certain embodiments, the content processing may also involve encoding of the content or otherwise changing the format or resolution of the content 122 for the receipt and decoding by a rendering device such as an upscaler 130. The content processing 120 provides metadata 124 to accompany content 122.

The rendering device 130 can be an upscaler, upconversion device, or the like that is used for the rendering of the content at a desired resolution. In accordance with the present disclosure, the rendering device 130 receives the metadata 124 along with the content 122. The rendering device 130 can then use the metadata 124 to optimizes the rendering of the content. In certain embodiments, this includes the upscaling of visual effects from a lower resolution to a higher resolution.

Examples of metadata fields for video processing include:

Metadata—Luminance

Metadata—Chrominance

Metadata—Block Size

Metadata—Bit Depth

Metadata—Motion Vectors

Metadata—Noise Reduction Parameters

Metadata—Motion Estimation

Metadata—Quantization Levels

Metadata—Color Information for High Dynamic Range

Metadata—Other

It is envisioned that such metadata fields and metadata can be used in a processor within rendering device 130 to enhance the rendering of video. In one example, rendering device 130 has an up-scaling chip (the “VTV-122x” provided by Marseille Networks) that can use received metadata to upscale received video for rendering.

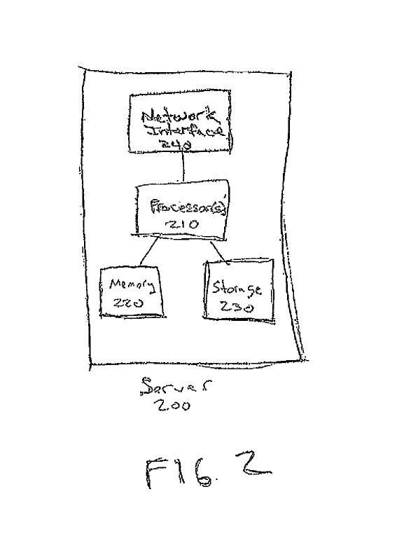

FIG. 2 depicts an exemplary electronic device 200 that can be used to implement the methodology and system for video optimization. The electronic device 200 includes one or more processors 210, memory 220, storage 230, and a network interface 240. Each of these elements will be discussed in more detail below.

The processor 210 controls the operation of the electronic device 200. The processor 210 runs the software that operates the electronic device as well as provides the functionality video optimization such as the content processing 120 shown in FIG. 1. The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media.

The storage 230 is where the data used and produced by the processor in executing the content analysis is stored. The storage may be magnetic media (hard drive), optical media (CD/DVD-Rom), or flash based storage. Other types of suitable storage will be apparent to one skilled in the art given the benefit of this disclosure.

The network interface 240 handles the communication of the electronic device 200 with other devices over a network. Examples of suitable networks include Ethernet networks, Wi-Fi enabled networks, cellular networks, and the like. Other types of suitable networks will be apparent to one skilled in the art given the benefit of the present disclosure.

It should be understood that the elements set forth in FIG. 2 are illustrative. The electronic device 200 can include any number of elements and certain elements can provide part or all of the functionality of other elements. Other possible implementation will be apparent to on skilled in the art given the benefit of the present disclosure.

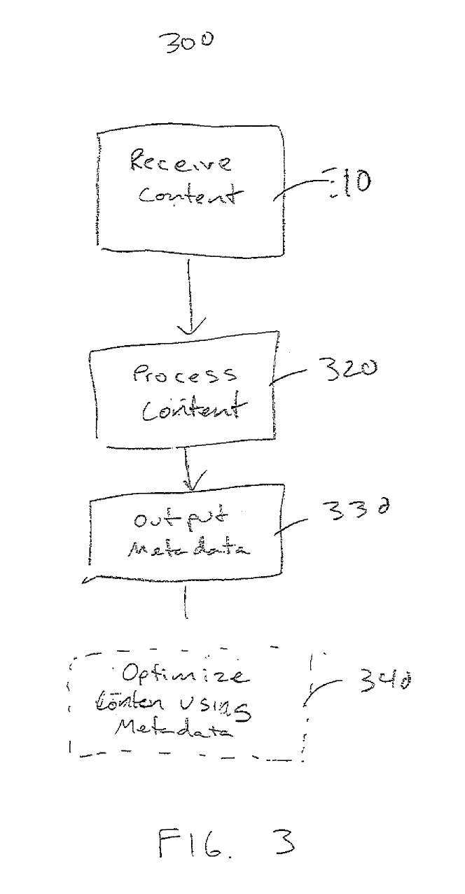

FIG. 3 is an exemplary flow diagram 300 for the process of video optimization in accordance with the present disclosure. At its base, the process involves the three steps of receiving content 310, processing content 320, and outputting metadata related to the content 330. In certain embodiments, the process further involves optimizing the rendering of the content using the metadata 340. Each of these steps will be described in more data below.

As set forth above in reference to FIG. 1, the content 112 is received from the content source 110 (step 310). The content 112 can be in any number of formats and resolutions. In one example, the content is a visual effect in a first resolution. Examples of visual effects include, but are not limited: to matt paintings, live action effects (such as green screening), digital animation, and digital effects (FX). In certain embodiments, the first resolution the visual effect is provided in is standard (480i, 480P) or high definition resolution (720p, 1080i, 1080p).

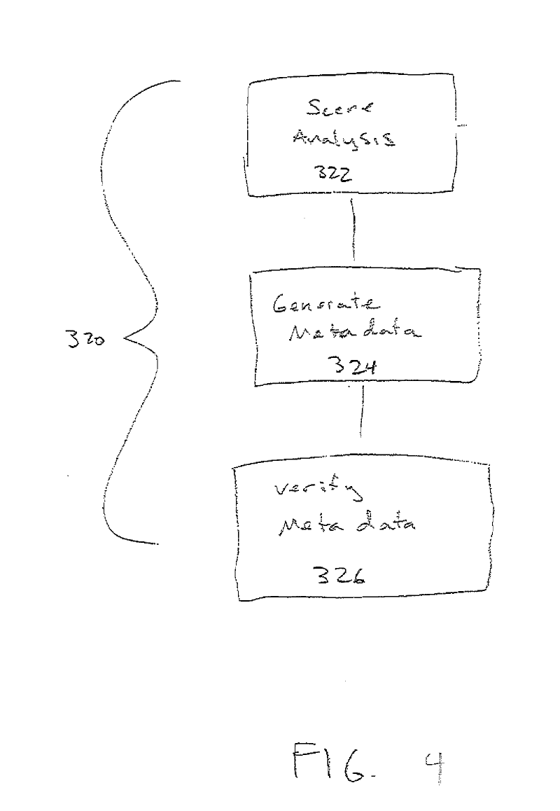

The processing of the content (for example, visual effects in a first resolution) 112 (step 320) is performed at the content processing 120 of FIG. 1. Here the content is analyzed to determine how to best optimized the rendering of the content. This can be performed by a person or a computer system, or a combination of both. This can be done in a scene-by-scene or shot-by-shot manner that provides a time code based mapping of image optimization requirements. An example of this can be seen in FIG. 4.

FIG. 4 depicts an exemplary flowchart of one methodology for processing video content, such as visual effects at a first resolution (step 320). It involves scene analysis (step 322), metadata generation (step 324), and metadata verification (step 326). Each of these steps will be discussed in further detail below.

In scene analysis (step 320), each scene of the visual effect(s) is identified and the time codes for the scene are marked. Each scene is then broken down or otherwise analyzed regarding the parameters of the scene that may require optimization. In certain embodiment, the analysis may also include analysis of different areas or regions of each scene.

Some such parameters for optimization include, but are not limited to, high frequency or noise, high dynamic range (HDR), the amount of focus in the scene or lack of focus in the scene, amount of motion, color, brightness and shadow, bit depth, block size, and quantization level. In certain embodiments, the parameters may take into account the rendering abilities and limitations of rendering hardware performing the eventual optimization. Other possible parameters will be apparent to one skilled in the art given the benefit of this disclosure.

It is then determined how to best optimize the visual effects content using such parameters. In certain embodiments this includes how to best upscale the video effects content from a lower resolution to a higher resolution. In still other embodiments, this analysis can involve the encoding of the visual effects content or otherwise changing the format or resolution of the content for the receipt and decoding by a rendering device, such as an upscaler 130. For example, some scenes may have a higher concentration of visual effects, or shots may push into a very detailed image, or may have a very high contrast ratio.

In one embodiment, visual effects are typically made up of computer generated content on top of a transparent background. The process of up-scaling content blurs the color and transparency of the pixels in the image. Therefore steps can be performed that make the process of up-scaling visual effects more efficient or make the results look better. For example, areas of the image that are transparent do not need to have their image values averaged with neighboring pixels. This can speed up the up-scaling process. Also, computer generated elements often have edges that may have visual artifacts if they are blurred with the transparent backgrounds during up-scaling, so that can be avoided or enhanced depending on the type of material. By outputting depth information from the computer generated element it might be possible to more accurately set the transparency for the up-scaled output.

These and other situations may require an adjustment to various settings for noise, chroma and scaling to avoid artifacts and maximize the quality of the viewing experience. The optimizations can also account for the abilities or limitations of the hardware being used for the rendering or upscaling of the visual effects content.

The results of the scene and optimization analysis can be translated or otherwise converted to metadata (step 324). The metadata can be instructions for the rendering device 130 as to how to best optimize rendering of the visual effects content. For example, the metadata can include code or hardware specific instructions for the upscaler and/or decoder of the rendering device 130. In certain embodiments the metadata is time synched to the particular scene that was analyzed in the scene analysis process.

Examples of such metadata instructions can include generic parameters such as sharpness, contrast, or noise reduction. The metadata may also include specific instructions for different types of devices or hardware. Other possible metadata will be apparent to one skilled in the art given the benefit of this disclosure.

Once the metadata has been generated (step 324) it can then be verified (step 326) to determine that metadata achieves the desired result or otherwise does not adversely affect the desired optimization, such as upscaling or rendering of content. This can be performed by using the metadata for the desired optimization and reviewing the result. The parameters and/or metadata can then be further adjusted as necessary. Once verified, the metadata is then ready to be provided or otherwise outputted for use in rendering optimization.

As set forth above, any of the processing steps can be performed by a human user, a machine, or combination thereof.

As part of this process, a master or reference file can then be created for each piece of content. The file can involve two elements:
1) Stage 1: Scene by scene and/or frame by frame analysis of factors that would affect image quality. This analysis would involve both automated and human quality observation of the before and after comparison, and technical description of factors that would affect image quality. By defining these factors, it is viable for an automated authoring system to provide analysis of conditions that are then capable of being tagged for insertion as metadata.
2) Stage 2: This metadata can be encoded into an instruction set for the rendering and up-scaling chips to adjust their settings, thereby optimizing the viewing experience and minimizing the occurrence of artifacts displayed on the screen.

Referring back to FIG. 3, after the metadata is output (step 330) the metadata can then be used to optimize the rendering of the content (step 340). In certain embodiments this is performed by an electronic device, such as shown in FIG. 2, configured for rendering.

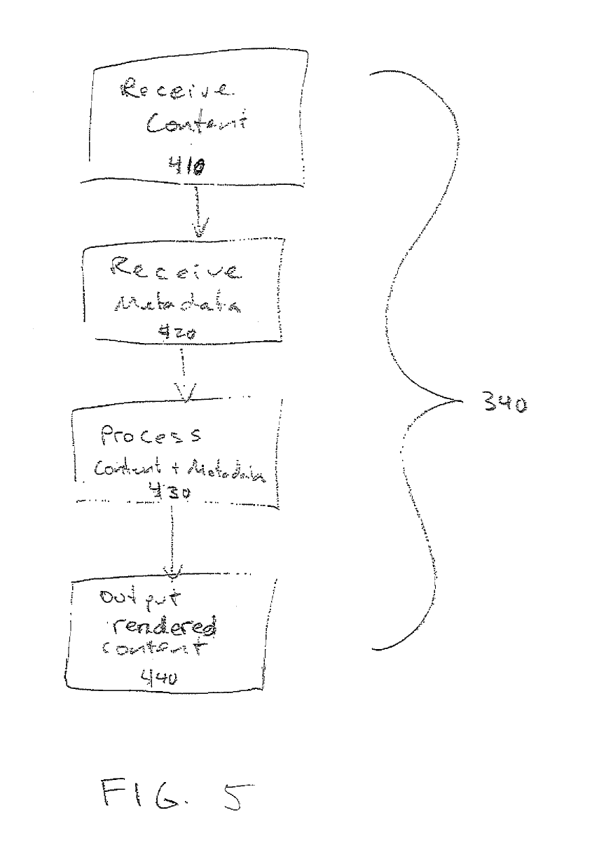

FIG. 5 depicts an exemplary flowchart of one methodology for optimizing rendering of video effects content using metadata (step 340). It involves the receipt of the content to be optimized (step 410), the receipt of metadata to be used in the optimization (step 420), the processing of the content and data for optimization (step 430) and the output of the optimized data (step 440). Each of these steps will be discussed in further detail below.

The receipt of the content (step 410) can be from a media file provided on storage mediums, such as DVDs, Blu-Rays, flash memory, or hard drives. Alternatively, the content file can be downloaded or provided as a data file stream over a network. Other possible delivery mechanism and formats will be apparent to one skilled in the art given the benefit of this disclosure.

Like the content, the receipt of the metadata (step 420) can be from a media file provided on storage mediums, such as DVDs, Blu-Rays, flash memory, or hard drives. Alternatively, the metadata file can be downloaded or provided as a data file stream over a network. Other possible delivery mechanism and formats will be apparent to one skilled in the art given the benefit of this disclosure.

Once the content and related metadata for optimization are received, the content and related metadata can be processed (step 430). This involves implementing the instructions provided by the metadata for handling or otherwise presenting the visual effects content. As such, the metadata may include adjustment to various settings for noise, chroma, and scaling to avoid artifacts and maximize the quality of the viewing experience. The optimizations of the metadata can also account for the abilities or limitations of the hardware being used for the rendering of the visual effects content.

This process allows for the upscaling of visual effects from a first resolution, such as standard or high resolution to a second resolution, such ultra high resolution (4K) The up-scaled or otherwise optimized visual effects at the second resolution can then be combined with content natively in the second resolution (ultra high resolution).

A master file defining the key optimization elements can then be created for key visual effects (VFX) and image sequences to integrate with the Original 4K Camera Negative. The cost of the creating visual effects in the first resolution and then upscaling (but with added authoring of all VFX) in this scenario substantially is less then producing the visual effects natively in ultra high resolution (4K). The compositing, CGI and storage can be performed in the first resolution keeping the cost down. Only final deliverable element needs to be in the second resolution (4K). Such visual effects content in the second resolution can then be inserted into a 4K conformed master.

As part of ultra high resolution (4 k) Master integration, sequences can be dropped in as regular VFX into a 4K conformed master, and color corrected for continuity. Thus the occurrence of artifacts displayed on the screen for complex sequences can be minimized.

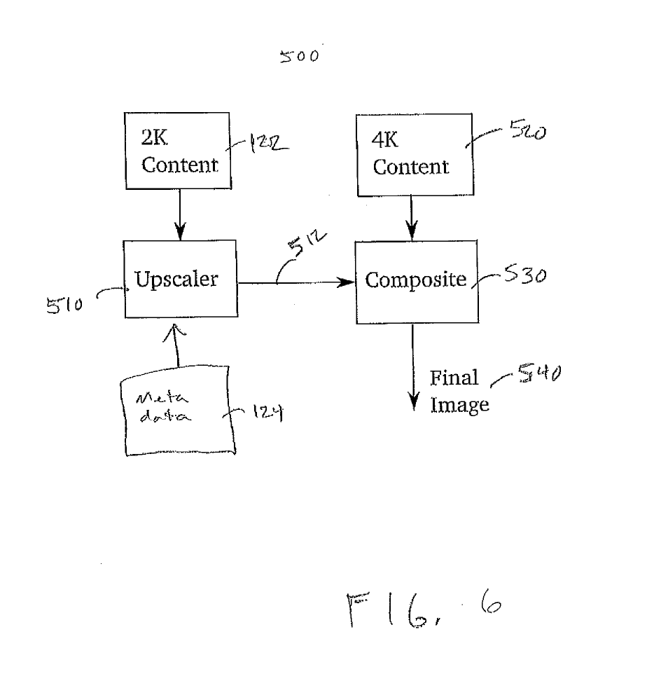

FIG. 6 provides an exemplary diagram 500 of such ultra high resolution mastering using lower resolution content. Here the lower resolution content 122, such as visual effects shots as a first resolution, are provided with the metadata 124 generated by the processing to a rendering device, in this case upscaler 510. The upscaled visual effects shots, now at a second resolution 512 can then be integrated with higher resolution content 520 at the second resolution, here 4K native content, by compositer 530 to produce the final image 540 comprising both the upscaled visual effects 512 and the original high resolution content 520.

The exemplary embodiments provided using the term rendering can also be performed using upscaling, downscaling, up-conversion, down-conversion, any other type of similar operation that changes video content from a first format to a second format and/or changes an attribute of video content during a processing operation, where such a change is controlled by metadata in accordance with the exemplary embodiments.

All examples and conditional language recited are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. Having described certain embodiments (which are intended to be illustrative and not limiting), it is noted that modifications and variations can be made by persons skilled in the art in light of the above teachings.

1. A method for optimizing the rendering of visual effects, the method comprising:
receiving visual effect content in a first resolution;
processing the visual effect content to generate metadata for use in rendering the visual effect content in a second resolution; and
providing the metadata for use in rendering the visual effect content in a second resolution.

2. The method of claim 1, wherein the rendering of the visual effect content comprises upscaling the visual effect content from a lower first resolution to a second higher resolution.

3. The method of claim 2, wherein the first resolution is high definition resolution and the second resolution is ultra high definition resolution.

4. The method of claim 1, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

5. The method of claim 1, wherein the metadata comprises metadata specific to a rendering device.

6. The method of claim 1, wherein processing the visual effect content further comprises:
analyzing scenes of the visual effect content for parameters for adjustment;
generating metadata for adjusting parameters for analyzed scenes; and
verifying the metadata.

7. An apparatus for optimizing the playback of video content, the apparatus comprising:
a storage device for storing video content;
a memory for storing data for processing; and
a processor in communication with the storage device and memory, the processor configured to receive visual effect content in a first resolution, process the visual effect content to generate metadata for use in rendering the visual effect content in a second resolution, and provide the metadata for use in rendering the visual effect content in a second resolution.

8. The apparatus of claim 7, wherein the rendering of the visual effect content comprises by upscaling the visual effect content from a lower first resolution to a second higher resolution.

9. The apparatus of claim 8, wherein the first resolution is high definition resolution and the second resolution is ultra high definition resolution.

10. The apparatus of claim 7, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

11. The apparatus of claim 7, wherein the metadata comprises metadata specific to a playback device.

12. The apparatus of claim 7, wherein the processor is further configures to analyze scenes of the video content for parameters for adjustment, generate metadata for adjusting parameters for analyzed scenes, and verify the metadata.

13. A machine readable medium containing instructions that when executed perform the steps comprising:
receiving visual effect content in a first resolution;
processing the visual effect content to generate metadata for use in rendering the visual effect content in a second resolution; and
providing the metadata for use in rendering the visual effect content in a second resolution.

14. The medium of claim 13, wherein the rendering of the visual effect content comprises upscaling the visual effect content from a lower first resolution to a second higher resolution.

15. The medium of claim 14, wherein the first resolution is high definition resolution and the second resolution is ultra high definition resolution.

16. The medium of claim 13, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

17. The medium of claim 13, wherein the metadata comprises metadata specific to a rendering device.

18. The medium of claim 13, wherein processing the visual effect content further comprises:
analyzing scenes of the visual effect content for parameters for adjustment;
generating metadata for adjusting parameters for analyzed scenes; and
verifying the metadata.

19. A method of rendering visual effect content using metadata comprising:
receiving visual effect content at a first resolution;
receiving metadata for optimizing the rendering of the visual effect content;
processing the visual effect content and metadata; and
outputting visual effect content at a second resolution.

20. The method of claim 19 further comprising combining the visual effects content at the second resolution with other video content at the second resolution.

21. The method of claim 19, wherein the rendering of the visual effect content comprises upscaling the visual effect content from a lower first resolution to a second higher resolution.

22. The method of claim 21, wherein the first resolution is high definition resolution and the second resolution is ultra high definition resolution.

23. The method of claim 19, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

24. The method of claim 19, wherein the metadata comprises metadata specific to a rendering device.

25. An apparatus for rendering the visual effect content using metadata, the apparatus comprising:
a storage device for storing video content;
a memory for storing data for processing; and
a processor in communication with the storage device and memory, the processor configured to receive visual effect content at a first resolution, receive metadata for optimizing the rendering of the visual effect content, process the visual effect content and metadata, and output visual effect content at a second resolution.

26. The apparatus of claim 25, wherein the processor is further configured to combine the visual effects content at the second resolution with other video content at the second resolution.

27. The apparatus of claim 25, wherein the rendering of the visual effect content comprises upscaling the visual effect content from a lower first resolution to a second higher resolution.

28. The apparatus of claim 26, wherein the first resolution is high definition resolution and the second resolution is ultra high definition resolution.

29. The apparatus of claim 25, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

30. The apparatus of claim 25, wherein the metadata comprises metadata specific to a rendering device.

31. A machine readable medium containing instructions that when executed perform the steps comprising:
receiving the visual effect content at a first resolution;
receiving the metadata for optimizing the rendering of the visual effect content;
processing the visual effect content and metadata; and
outputting visual effect content at a second resolution.

32. The medium of claim 31 further comprising combining the visual effects content at the second resolution with other video content at the second resolution.

33. The medium of claim 31, wherein the rendering of the visual effect content comprises upscaling the visual effect content from a lower first resolution to a second higher resolution.

34. The medium of claim 33 wherein, the first resolution is high definition resolution and the second resolution is ultra high definition resolution.

35. The medium of claim 31, wherein the metadata comprises metadata regarding at least one parameter selected from the group comprising: Luminance, Chrominance, Block Size, Bit Depth, Motion Vectors, Noise Reduction Parameters, Motion Estimation, Quantization Levels, and Color Information for High Dynamic Range.

36. The medium of claim 31, wherein the metadata comprises metadata specific to a rendering device.
